(19) United States
(12) Patent Application Publication
(10) Pub. No.: US 2017/0197274 A1
(43) Pub. Date: Jul. 13, 2017

(54) MECHANICAL FLOW JOINING OF HIGH MELTING TEMPERATURE MATERIALS

(71) Applicants: John T. Canavan, North Versailles, PA (US); Michael D. Klinginsmith, Moreland Hills, OH (US); MegaStir Technologies LLC, Provo, UT (US)

(72) Inventors: Russell J. Steel, Salem, UT (US); Rodney Dale Fleck, Mansfield, TX (US); Christopher Arthur Tucker, Provo, UT (US); Scott M. Packer, Alpine, UT (US); David Rosal, West Bountiful, UT (US); John T. Canavan, North Versailles, PA (US); Michael D. Klinginsmith, Moreland Hills, OH (US)

(21) Appl. No.: 15/324,850

(22) PCT Filed: Jul. 9, 2015
(86) PCT No.: PCT/US2015/039785

§ 371 Date: Jan. 9, 2017

Related U.S. Application Data
(60) Provisional application No. 62/023,166, filed on Jul. 10, 2014.

(51) Int. Cl. B23K 11/00; B23K 20/22; B23K 20/12

(52) U.S. Cl. CPC B23K 11/0053; B23K 20/1265; B23K 20/128; B23K 20/22; B23K 2203/05

(57) ABSTRACT

A system and method for securely joining a high melting temperature material and a backing substrate using a mechanical connection includes a backing substrate integrally formed with a material positioned inside a dovetail recess in the high melting temperature material, mechanically fixing the backing substrate to the high melting temperature material without fusion or bonding of the microstructure.

### CROSS-REFERENCE TO RELATED APPLICATIONS

This application claims priority to and the benefit of U.S. Provisional Patent Application No. 62/026,166, filed Jul. 10, 2014, the disclosure of which is incorporated herein by reference in its entirety.

### BACKGROUND

Friction stir joining is a technology that has been developed for welding metals and metal alloys. Friction stir welding is generally a solid state process that has been researched, developed, and commercialized over the past 20 years. Solid state processing is defined herein as a temporary transformation into a plasticized state that may not include a liquid phase. However, it is noted that some embodiments allow one or more elements to pass through a liquid phase.

Friction stir joining began with the joining of aluminum materials because friction stir joining tools could be made from tool steel and adequately handle the loads and temperatures that may be needed to join aluminum. Friction stir joining has continued to progress into higher melting temperature materials (HMTMs) such as steels, nickel base alloys and other specialty materials because of the development of superabrasive tool materials and tool designs capable of withstanding the forces and temperatures that may be needed to flow these higher melting temperature materials.

It is understood that the friction stir joining process often involves engaging the material of two adjoining planar workpieces on either side of a joint by a rotating stir pin. Force is exerted to urge the pin and the workpieces together and frictional heating caused by the interaction between the pin, shoulder and the workpieces results in plasticization of the material on either side of the joint. The pin and shoulder combination or “FSW tip” is traversed along the joint, plasticizing material as it advances, and the plasticized material left in the wake of the advancing FSW tip cools to form a weld. The FSW tip may also be a tool without a pin so that the shoulder is processing another material through FSP.

FIG. 1 is a perspective view of a tool being used for friction stir joining that is characterized by a generally cylindrical tool 10 having a shank, a shoulder 12 and a pin 14 extending outward from the shoulder. The pin 14 is rotated against a workpiece 16 until sufficient heat is generated, at which point the pin of the tool is plunged into the plasticized planar workpiece material. In this example, the pin 14 is plunged into the planar workpiece 16 until reaching the shoulder 12 which prevents further penetration into the workpiece. The planar workpiece 16 is often two sheets or plates of material that are butted together at a joint line 18. In this example, the pin 14 is plunged into the planar workpiece 16 at the joint line 18.

Referring to FIG. 1, the frictional heat caused by rotational motion of the pin 14 against the planar workpiece material 16 causes the workpiece material to soften without reaching a melting point. The tool 10 is moved transversely along the joint line 18, thereby creating a weld as the plasticized material flows around the pin from a leading edge to a trailing edge along a tool path 20. The result is a solid phase bond at the joint line 18 along the tool path 20 that may be generally indistinguishable from the material of the workpiece 16, in contrast to the welds produced when using conventional non-FSW welding technologies.

It is observed that when the shoulder 12 contacts the surface of the planar workpieces, rotation of the shoulder creates additional frictional heat that plasticizes a larger cylindrical column of material around the inserted pin 14. The shoulder 12 provides a forging force that contains the upward metal flow caused by the tool pin 14.

During friction stir joining, the area to be joined and the tool are moved relative to each other such that the tool traverses a desired length of the weld joint at a tool/workpiece interface. The rotating friction stir welding tool 10 provides a continual hot working action, plasticizing metal within a narrow zone as it moves transversely along the base metal, while transporting metal from the leading edge of the pin 14 to its trailing edge. As the weld zone cools, there is no solidification as no liquid is created as the tool 10 passes. It may be the case that the resulting weld is a defect-free, re-crystallized, fine grain microstructure formed in the area of the weld.

Friction stir welding of high melting temperature materials may require the use of specialized equipment. For example, it may require the use of a polycrystalline cubic boron nitride tool, a liquid cooled tool holder, a temperature acquisition system, and the proper equipment to have a controlled friction stir welding process. The present disclosure is also applicable to lower melting temperature materials such as aluminum and other metals and metal alloys that are not considered part of the high melting temperature materials.

This document also addresses methods of mechanically joining components. A mechanical joint may be useful when components are removed or replaced after use. Mechanical joints include using fasteners such as screws, bolts, rivets, rods and cotter pins, zip ties, paper clips, etc. Mechanical joints may be used in applications where the operating environment is particularly harsh such as in aerospace, oil and gas exploration, mining and others. These applications may benefit from a more permanent fusion joining method such as a weld or a brazed joint. However, fusion joining methods may not be practical because of potential thermal damage to the parts, distortion that prevents fit up with mating parts, solidification defects, safety, cost or simply that the materials being joined cannot be fusion joined due to the physical properties of the materials.

An example is given where the state of the art fails to provide an adequate solution. Mining of coal and minerals may require equipment that is continually exposed to hard rocks, abrasive minerals and random materials encountered during the mining operation. In order to minimize machine component wear of the equipment that is caused by exposure to this environment, abrasion resistant materials are employed in the manufacture of the equipment. These materials are designed as consumable components that may be continually replaced.

One of the most common abrasion or wear resistant materials used in equipment that is subjected to severe wear environments is cemented tungsten carbide or tungsten carbide. Mining equipment may use thick section tungsten carbide to line machine surfaces that are in contact with minerals, rocks, abrasive materials or other materials being extracted from the earth. Tungsten carbide is a common material of choice because of its very high hardness and resistance to wear under extreme conditions.

The process of manufacturing tungsten carbide may use a powder including tungsten carbide crystals and cobalt. This mixture may be cold pressed together with a binder to form a “green” state which is then formed to a desired shape. The green state may be characterized as being relatively soft, like chalk, which may then be formed and/or machined into a variety of shapes. After the green state mixture has been formed, it may be put through a high temperature/vacuum or a high temperature/high pressure sintering process that may cause it to shrink by up to 48% by volume. Shrinkage may be more or less.

The sintering process may give tungsten carbide its high hardness but may also leave it brittle compared to steel and other ferrous alloys. The sintered carbide component may then be ground to a finished size according to application requirements.

Because tungsten carbide is brittle, sharp corners should not be designed or integrated into the design of the carbide component. Sharp corners may be stress raisers and may create cracking during the sintering process or during subsequent usage in an application. As a result, it may be difficult to include certain features into the design of the carbide component such as threads to hold bolts and other conventional features that function as locking mechanisms because they may have sharp corners. Accordingly, it may be difficult to find a method to secure tungsten carbide components to equipment or to a surface that is exposed to the high loads that may be generated during mining and excavation operations.

It is noted that there are many materials such as ceramics, cermets (ceramic-metallic), intermetallics, as well as other high strength materials that may not be readily joined and yet could be used wherever a wear resistant solution may be used for a number of applications.

An example is shown in FIG. 2. FIG. 2 is a perspective view of a tungsten carbide plate 30 attached to a steel weldable work piece 32 that in combination may be used as a wear resistant plate in a mining application. The tungsten carbide plate 30 may be attached to the steel weldable work piece 32 using adhesive or brazing. The steel weldable work piece 32 includes attachment studs 34 that have been welded to it. It is noted that any physical attachment device or mechanism such as the attachment studs 34 may be attached to the steel weldable work piece 32.

One of the aspects with the design shown in FIG. 2 is that a tungsten carbide plate that is large enough to be used as a wear resistant plate may be a non-weldable material and may crack if any weld were attempted.

As for attaching the tungsten carbide plate 30 to the steel weldable work piece 32 using adhesive, applications of using the assembly may generate substantial heat from frictional wear which may cause the adhesive to decompose and delaminate the tungsten carbide from the steel weldable work piece substrate. Other aspects of using an adhesive may include, but should not be considered as limited to, poor performance in very cold conditions, premature failure due to low strength or brittle failure, poor chemical resistance to acidic compounds, and the mechanical strength of adhesives is inherently very low and high shear forces generated by rock and debris may pull the tungsten carbide from the substrate during equipment operation.

Another known joining method is brazing, which also has limitations. The braze material along with the components to be joined may need to be heated to 600° C. to 1100° C. In this case, the thermal expansion of the steel weldable work piece 32 is much greater than the thermal expansion of the tungsten carbide plate 30. During the cooling process, residual stresses may be introduced at the joint between them as the steel weldable work piece 32 contracts more than the tungsten carbide plate 30. This may effectively reduce the strength of the joint to that of an adhesive.

### BRIEF SUMMARY

The present disclosure is a system and method for securely join together a high melting temperature material and a backing substrate or plate using a mechanical connection.

In a first aspect, a friction-stir joined assembly includes a high melting temperature material forming a plate having an outer surface and an opposite attaching surface. At least one dovetailed recess may be disposed in the attaching surface, and then an insert may be disposed in the dovetailed recess. A weldable work piece may be disposed against the attaching surface and then friction stir welded to the insert. The insert may form an interference fit inside the dovetailed recess after friction stir welding. An attachment device may be then coupled to the weldable work piece so that the assembly can be attached to a piece of equipment or other device that can use a wear resistance surface.

In another aspect, the same friction-stir joined assembly is created but without the insert. During friction stirring of the weldable work piece, material from the weldable work piece is extruded into the dovetailed recess until an interference fit is created.

In another aspect, the friction-stir joined assembly is created without using a high melting temperature material but may be the same in other respects.

In another aspect, a method for creating the friction-stir joined assembly includes forming a non-weldable work piece into a desired shape before it is hardened and then selecting an outer surface and an opposite attaching surface. A plurality of dovetailed recesses is also formed in the attaching surface before hardening of the non-weldable work piece. An insert is then disposed into each of the dovetailed recesses. An attachment device is then coupled to the weldable work piece so that the assembly can be attached to a piece of equipment or other device that can use a wear resistance surface.

In another aspect, the dovetailed recesses are formed after the non-weldable work piece is hardened.

In another aspect, the same friction-stir joined assembly is created but without the inserts. During friction stirring of the weldable work piece, material from the weldable work piece is extruded into the dovetailed recess until an interference fit is created.

In another aspect, at least two recesses are created in the high melting temperature material, the recesses not being perpendicular to the attaching surface but at an angle relative to each other. A weldable work piece is friction stir welded to inserts that are disposed inside of each of the recesses, the angle of the recesses keeping the high melting temperature material coupled to the weldable work piece.

In another aspect, at least two recesses are created in the high melting temperature material, the recesses are not being perpendicular to the attaching surface but at an angle relative to each other. By extruding material into the recesses from a weldable work piece, the angle of the recesses keeps the high melting temperature material coupled to the weldable work piece.

These and other embodiments of the present will become apparent to those skilled in the art from a consideration of the following detailed description taken in combination with the accompanying drawings.

### BRIEF DESCRIPTION OF THE DRAWINGS

FIG. 1 is a perspective view of the prior art illustrating friction stir welding of workpieces.

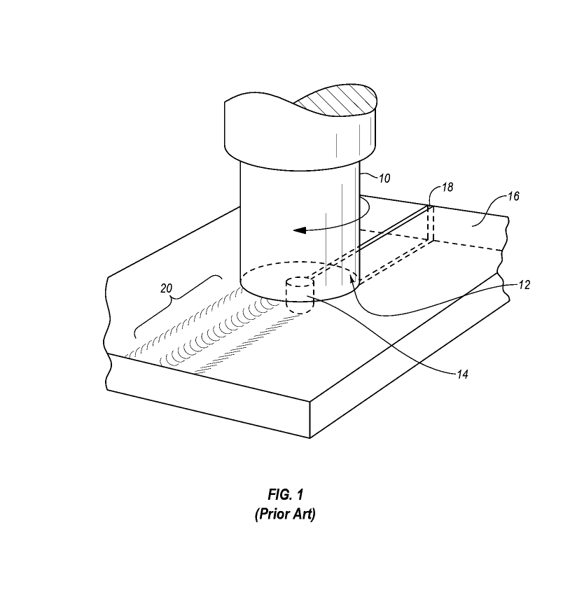

FIG. 2 is a perspective view of the prior art illustrating a non-weldable material joined by adhesive or brazing to a weldable work piece.

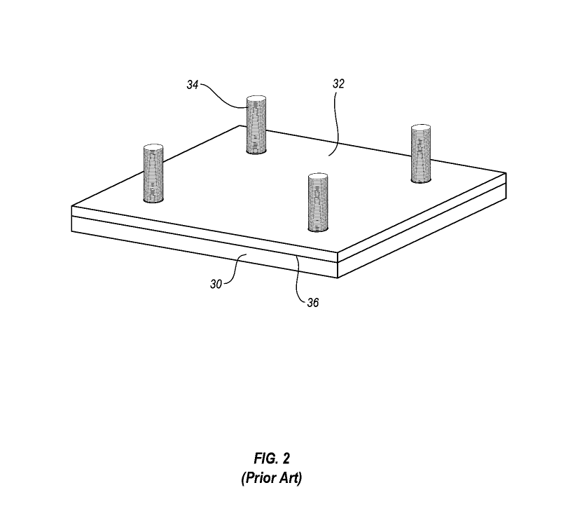

FIG. 3 a perspective view of a non-weldable work piece that is manufactured in accordance with the principles of the present disclosure.

FIG. 4 is a cross-sectional view of a groove that is shown perpendicular to a long axis or length.

FIG. 5 is a perspective view of the non-weldable work piece and the bars are disposed in the grooves.

FIG. 6 is a perspective view illustrating a weldable work piece that is disposed on the side of the non-weldable work piece that has the grooves and the bars as shown in FIG. 5.

FIG. 7 is a perspective view illustrating that a friction stir welding tool is brought in contact with the weldable work piece in order to join the steel weldable work piece to the steel bars and thereby create a friction-stir joined assembly.

FIG. 8 is a cross-sectional view illustrating the friction stir welding tool having penetrated both the weldable work piece and the bars.

FIG. 9 is a perspective view of the friction-stir joined assembly 50 that is completed by adding attachment devices to the weldable work piece.

FIG. 10 is a perspective view of a chute leading to a conveyor belt.

FIG. 11 is a perspective view of other features may be added to the grooves.

FIG. 12 is a perspective view illustrating a non-weldable work piece that is arcuate.

FIG. 13 is a cross-sectional view of the non-weldable work piece shown in FIG. 12.

FIG. 14 is three views of a tubular high melting temperature object shown in perspective, from an end relative to a long axis, and perpendicular to the axis.

FIG. 15 is three views of a tubular weldable work piece object shown in perspective, from an end relative to a long axis, and perpendicular to the axis.

FIG. 16 is three views of a tubular assembly including the tubular objects shown in FIGS. 14 and 15 and shown in perspective, from an end relative to a long axis, and perpendicular to the axis.

FIG. 17 is a perspective view of a non-weldable work piece having a dovetailing depression or recess.

FIG. 18 is a side cross-sectional view of a weldable member extruded into a hole in a non-weldable member.

FIG. 19 is a side cross-sectional view of a weldable member friction-stir welded into angled recesses in a non-weldable member.

### DETAILED DESCRIPTION

One or more specific embodiments of the present disclosure will be described below. In an effort to provide a concise description of these embodiments, some features of an actual embodiment may be described in the specification. It should be appreciated that in the development of any such actual embodiment, as in any engineering or design project, numerous embodiment-specific decisions will be made to achieve the developers' specific goals, such as compliance with system-related and business-related constraints, which may vary from one embodiment to another. It should further be appreciated that such a development effort might be complex and time consuming, but would nevertheless be a routine undertaking of design, fabrication, and manufacture for those of ordinary skill having the benefit of this disclosure.

One or more embodiments of the present disclosure may generally relate to the joining of a first material having a first strength and/or first ductility and a second material having a second strength and/or second ductility where the second strength is greater than the first strength and/or the second ductility is less than the first ductility. For example, a tool steel workpiece may be joined to a tungsten carbide workpiece. The tool steel, while having a high yield strength and low ductility, may still have a lower yield strength and greater ductility than the tungsten carbide. Tungsten carbide may be functionally non-weldable due to its high hardness and brittleness and low ductility. In another example, an aluminum alloy workpiece may be joined to a tool steel workpiece. The aluminum alloy, while having a high yield strength and low ductility compared to some materials, may still have a lower yield strength and greater ductility than the tool steel. The tool steel, while weldable by some processes including friction stir welding (“FSW”), may require specialized equipment or conditions that may render the tool steel non-weldable for a particular application.

As used herein, “non-weldable” should be understood to describe a material and/or workpiece that, given the equipment or conditions used to weld another material, is non-weldable. For example, a first material may be weldable by a given FSW tool capable of a certain speed of rotation, force applied normal to a workpiece, force applied lateral to a workpiece (e.g., to move the FSW tip along a path), movement speed, or other operational parameters. A second material may not be weldable by the given FSW tool, although the second material may be weldable by other equipment and/or conditions. Therefore, one should understand that the present disclosure may allow a given FSW tool to join a weldable material to a non-weldable material or, in other words, to a material which the given FSW tool may be unable to weld.

In some embodiments, a non-weldable material may include tungsten carbide, silicon carbide, alumina, cubic boron nitride, polycrystalline diamond, boron carbide, boron carbon nitride, materials having a hardness greater than 40 gigapascals (GPa) when measured by the Vicker's hardness test, or combinations thereof. In other embodiments, a non-weldable material may include steel, such as carbon steel (e.g., AISI 10XX, AISI 11XX, AISI 12XX, or AISI 15XX), manganese steel (e.g., AISI 13XX), nickel steel (e.g., AISI 23XX, or AISI 25XX), nickel-chromium steel (e.g., AISI 31XX, AISI 32XX, AISI 33XX, or AISI 34XX), molybdenum steel (e.g., AISI 40XX, or AISI 44XX), chromium-molybdenum steel (e.g., AISI 41XX), nickel-chromium-molybdenum steel (e.g., AISI 43XX, or AISI 47XX), nickel-molybdenum steel (e.g., AISI 46XX, or AISI 48XX), chromium steel (e.g., AISI 50XX, or AISI 51XX), combinations thereof, and the like, where “XX” may range from 1 to 99 and represents the carbon content; titanium alloys; nickel superalloys; other metal high melting temperature alloys.

A weldable material and/or a non-weldable material may be magnetic or non-magnetic. For example, the weldable workpiece may be a magnetic material or a non-magnetic material and the non-weldable workpiece may be a magnetic material or a non-magnetic material. In some embodiments described herein, a first workpiece made of or including a weldable material may be in contact with a second workpiece made of or including a non-weldable material. One, both, or neither of the workpieces may be magnetic. A workpiece that is magnetic may, in some embodiments, magnetize the adjacent workpiece.

Reference will now be made to the drawings in which the various embodiments will be given numerical designations and in which the embodiments will be discussed so as to enable one skilled in the art to make and use the embodiments of the disclosure. It is to be understood that the following description illustrates embodiments of the present disclosure, and should not be viewed as narrowing the claims which follow.

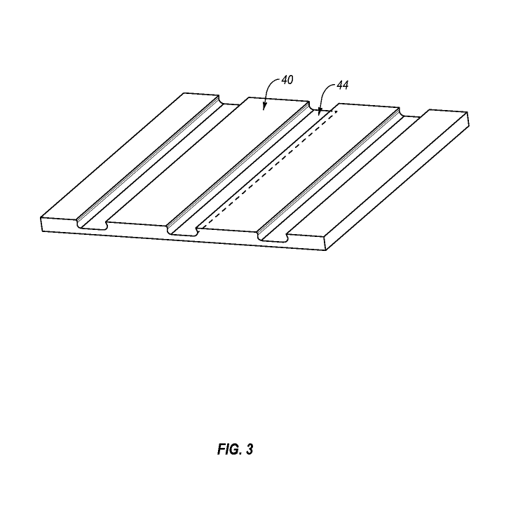

A first embodiment is shown in FIG. 3. FIG. 3 is a perspective view of a non-weldable work piece 40 that is manufactured in accordance with the principles of the present disclosure. The first embodiment may enable any non-weldable material to be securely joined to a weldable plate made from a different, weldable material. It should be understood that the principles of the present disclosure may enable any two dissimilar materials to be joined in this manner.

The shape of the non-weldable work piece 40 may be rectangular or any desired shape and should not be considered limited to the example being shown. As described herein, in some embodiments, the non-weldable workpiece may be a ceramic, a carbide, an ultrahard material, other material formed in a green state, or combinations thereof. In such embodiments, the desired shape may be created while the non-weldable work piece 40 is in the green state and then hardened.

FIG. 3 shows grooves 44 that are formed in the non-weldable work piece 40. The grooves 44 are formed in an attaching surface that is opposite to an outer surface in the non-weldable work piece 40. FIG. 3 shows that the grooves 44 may be formed from one end of the non-weldable work piece 40 to the other and thereby form sliding dovetail grooves. The grooves 44 may be parallel and uniformly spaced. In some embodiments, the grooves 44 may be formed while the non-weldable work piece 40 is in a green state before being hardened in the sintering process. For example, forming the grooves 44 when the non-weldable work piece 40 is in the green state enables formation of the dovetail.

The dovetailing grooves 44 may be described more generically as a dovetailing depression, recess, or cavity in the non-weldable work piece 40. The grooves 44 may be considered to be a specific case of a dovetailing recess.

In some embodiments, the grooves 44 may not extend from one end of the non-weldable work piece 40 to the other. One or both of the grooves 44 may not reach the ends of the non-weldable work piece 40. Furthermore, the grooves 44 may not be parallel and also not cross each other. In some embodiments, one or more of the grooves 44 may also cross one or more other grooves. In another embodiment, the grooves 44 may not be straight but may be arcuate. In some embodiments, the grooves 44 may be a combination of straight and arcuate segments.

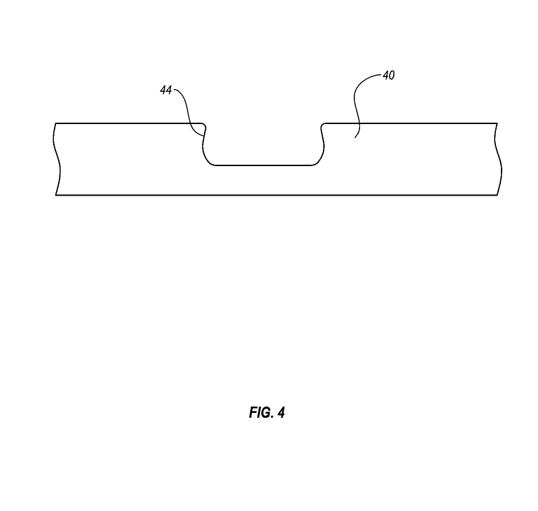

A feature that may be common to all of the grooves 44 is shown in FIG. 4. FIG. 4 is a cross-sectional view of a groove 44 that is shown perpendicular to a long axis or length. FIG. 4 shows that the grooves 44 may be sliding dovetail grooves, the entrance to the groove from above, as seen in profile, is narrower than the rest of the groove. One purpose of the dovetailed shape of the grooves 44 may be to resist cracking of the non-weldable work piece 40.

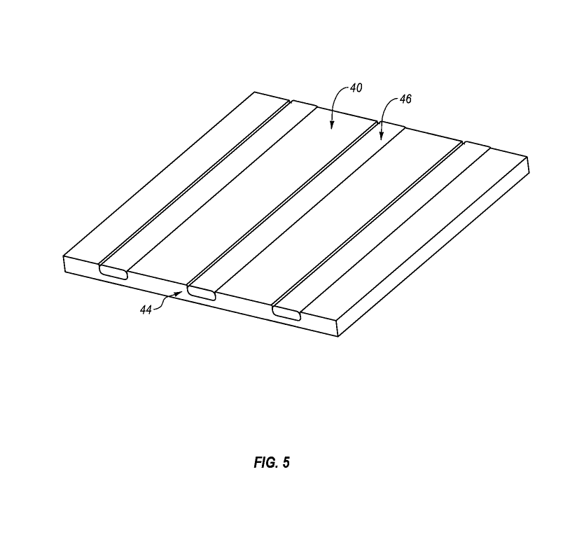

FIG. 5 shows a perspective view of the non-weldable work piece 40 with inserts 46 disposed in the grooves 44. In this first embodiment the inserts are in the shape of a bar, may be made of steel, and may be large enough that the inserts 46 cannot be pulled from the grooves 44 through the dovetailed opening in a direction that is perpendicular to a plane of the non-weldable work piece 40.

The material selected for the inserts 46 may be selected from but should not be considered as limited to the following materials including steel, stainless steel, aluminum, high nickel alloys such as Inconel or any other material that is capable of being friction stir welded.

In some embodiments, the inserts 46 may be made of a plurality of different materials. These different materials may be selected for a particular property that may be obtained from the combination. As an example, such materials may include but should not be considered as limited to a braze material, a corrosion resistant material, a material that may extrude further than other materials, and a material that may be more readily weldable by friction stir welding, by arc or fusion welding or both.

In some embodiments, different materials may be used in different areas of the inserts 46. For example, one material may be used in certain areas where an attachment device will be connected to the weldable work piece 42 in order to improve the strength of the point of attachment.

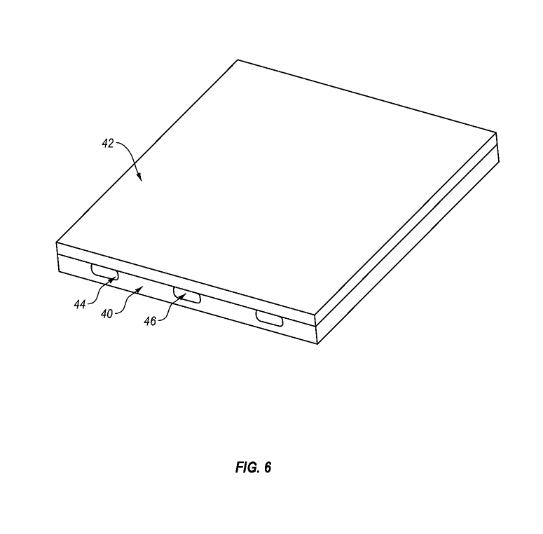

FIG. 6 shows in a perspective view that a weldable work piece 42 is placed on the side of the non-weldable work piece 40 that has the grooves and the inserts 46 as shown in FIG. 5. The weldable work piece 42 may or may not be flush with the non-weldable work piece 40. Nevertheless at least a portion of each of the inserts 46 may be sufficiently close to the weldable work piece 42 that they may be connected through friction stir welding.

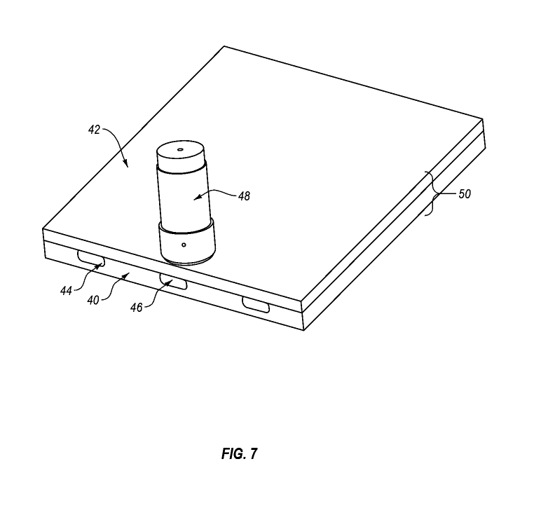

FIG. 7 shows in a perspective view that a friction stir welding tool 48 is brought in contact with the weldable work piece 42 in order to join the steel weldable work piece 42 to the steel inserts 46 and thereby create a friction-stir joined assembly 50 including at least the non-weldable work piece 40, the inserts 46 and the weldable work piece 42. It should be understood that the principles of the first embodiment may enable any two dissimilar materials, such as the non-weldable work piece 40 and the weldable work piece 42, to be joined in this manner.

It should be understood that the inserts 46 and the weldable work piece 42 may not be made of steel or may not be the same type of steel. Furthermore, the inserts 46 and the weldable work piece 42 may be made of different materials. However, the inserts 46 and the weldable work piece 42 should be made of materials that may be friction stir welded together. As long as the inserts 46 and the weldable work piece 42 may be joined using friction stir welding, then the friction-stir joined assembly 50 shown in FIG. 7 may be created.

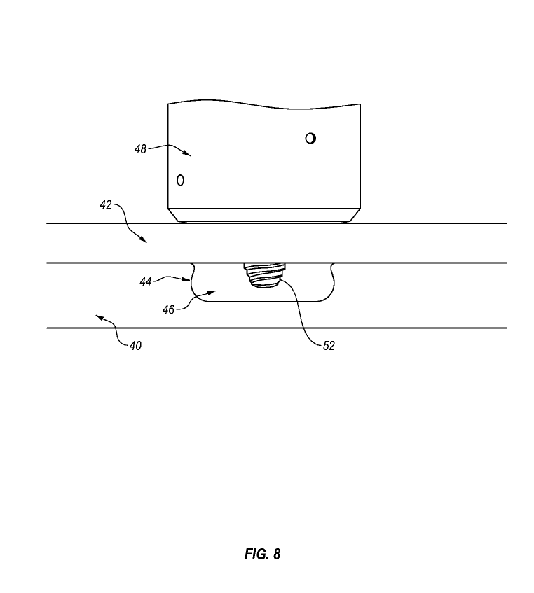

FIG. 8 is a cross-sectional view showing the friction stir welding tool 48 having penetrated both the weldable work piece 42 and the inserts 46. The pin 52 of the friction stir welding tool 48 may be long enough to completely penetrate the weldable work piece 42 and partially penetrate the inserts 46, but not long enough to make contact with the non-weldable work piece 40.

One aspect of this first embodiment is that when performing friction stir welding, this process will plasticize portions of the weldable work piece 42 and the inserts 46 that are near the friction stir welding tool, and causing them to flow to the degree as made possible by friction stir welding. It is desirable to fully extrude the material of the weldable work piece 42 and the inserts 46 into the grooves 44. The flow of the material in the weldable work piece 42 and the inserts 46 from friction stir welding may be sufficient to at least partially fill the grooves 44. The material of the weldable work piece 42 and the inserts 46 may not need to fill the entire cavity formed by the grooves 44, but enough to create an interference fit or a friction fit between the bars and the non-weldable work piece 40 that is forming the grooves. The interference fit may be strong enough to prevent the weldable work piece 42 and the inserts 46 from detaching from the non-weldable work piece 40 in a direction that is orthogonal to a plane of the non-weldable work piece 40, but also from sliding out of the grooves 44.

In some embodiments, the inserts 46 may not be disposed within the grooves 44. In such embodiments, the material from the weldable work piece 42 is extruded into the grooves 44 during penetration of the friction stir welding tool 48 into weldable work piece 42. Accordingly, even if no inserts 46 are present in the grooves 44, it has been determined that penetration of the friction stir welding tool 48 into the weldable work piece 42 may be sufficient to extrude sufficient material into the grooves 44 to create an interference fit between material from the weldable work piece 42 and the grooves 44.

In some embodiments, the inserts 46 may not be fitted to the grooves 44. In other words, the inserts 46 form a tight fit within the grooves 44 before friction stir welding. The inserts 46 may be loose fitting filler material. Extrusion from the weldable work piece 42 may fill in gaps between the loose fitting filler material and the grooves 44.

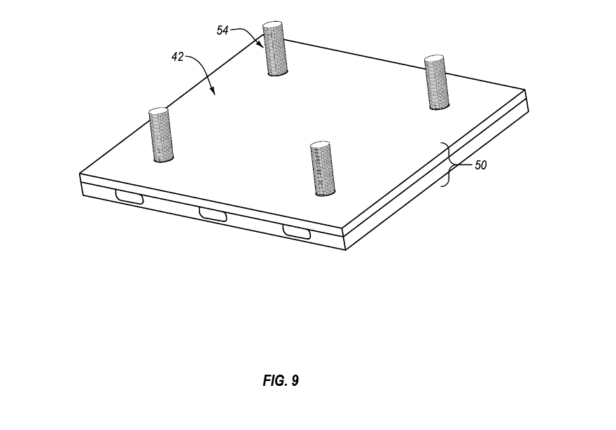

FIG. 9 is a perspective view of the friction-stir joined assembly 50. In FIG. 9, the friction-stir joined assembly 50 may be completed by adding attachment devices 54 to the weldable work piece 42. For example, threaded screws or studs are shown after being resistance welded to weldable work piece 42.

The weldable work piece 42 may be welded, machined, or altered in order to provide an accurate fit to equipment as a replaceable friction-stir joined assembly 50.

The attachment devices 54 should not be considered as limited to the threaded studs shown in FIG. 9, but should be considered to include any structure, feature or mechanism that can be attached to the weldable work piece 42 that may enable the friction-stir joined assembly 50 to be mechanically connected to another object. The attachment device or devices 54 may enable the friction-stir joined assembly 50 to be removable from whatever device they are attached to, but this is not required. Thus, the friction-stir joined assembly 50 may be temporarily or permanently attached to another device.

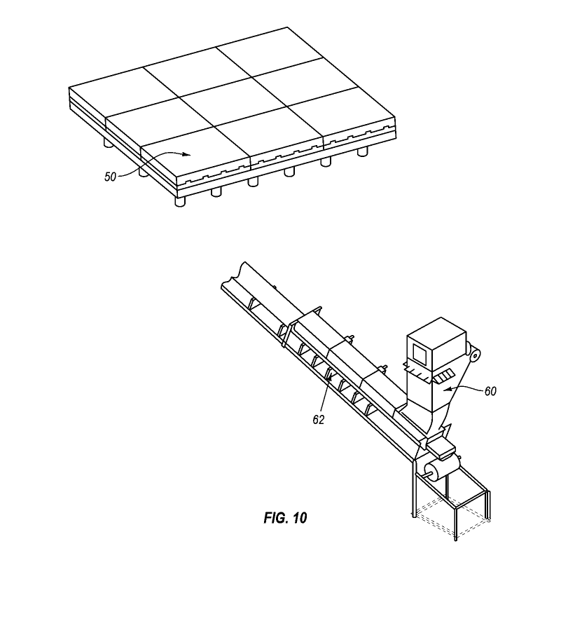

FIG. 10 is provided as a perspective view of a chute 60 leading to a conveyor belt 62. Rocks and minerals may fall down the chute 60 and onto the conveyor belt 62 to be carried away. The chute 60 and the conveyor belt 62 may be considered to be a severe wear environment having abrasive materials are moving against a containment system. The friction-stir joined assembly 50 may now be attached to provide wear resistance. In this example, wear resistance may be provided on the inside of chute 60 to prevent damage to the chute. For example, the friction-stir joined assembly 50 may be attached as a wear liner inside the chute 60. The friction-stir joined assembly 50 may be attached to the inside of the chute using the threaded attachment devices 54. The threaded attachment devices 54 may fit through holes in the chute 60 and then be attached with nuts on the outside of the chute. The friction-stir joined assembly 50 is then easily replaced by unscrewing the nuts and removing the friction-stir joined assembly 50. The friction-stir joined assembly 50 may then present the non-weldable work piece 40 to the rocks while being held firmly in place inside the chute 60 by the weldable work piece 42.

It should be understood that a chute is only one example of an environment in which the friction-stir joined assembly 50 of the first embodiment may be used. The chute is a wear environment in which an ultrahard material may be employed. Other embodiments of wear environments include but should not be considered as limited to mining and bulk material handling such as hoppers, mold boards, bang plates, classifiers, screw conveyor flights, centrifuge flights, distribution nozzles, and coal and ore cargo ship holds. Mineral processing includes such applications as cheek plates, edge rings, feed systems, crushers, and grinders. Valves and flow control applications include end plates, chokes, and rotary valves. Pump applications include impellers, liners, and seats. Power generation applications include combustion fans, pug mill trough liners and paddles, ash trough liners and paddles, combustion nozzles and crushers. Oil and gas applications include mud pumps, hydro heaters, artificial lift pumps and drill string stabilizers. A friction stir-joined assembly as described herein may be used in any industry or application to join one or more materials that are not weldable by friction stir-welding. For example, in addition to the wear resistance applications described, a friction stir-joined assembly as described herein may be used for thermal shielding, for providing low-friction or high-friction surfaces, for aesthetic purposes, other applications, and combinations thereof. These are only a few of the applications for the technology of all of the embodiments disclosed herein.

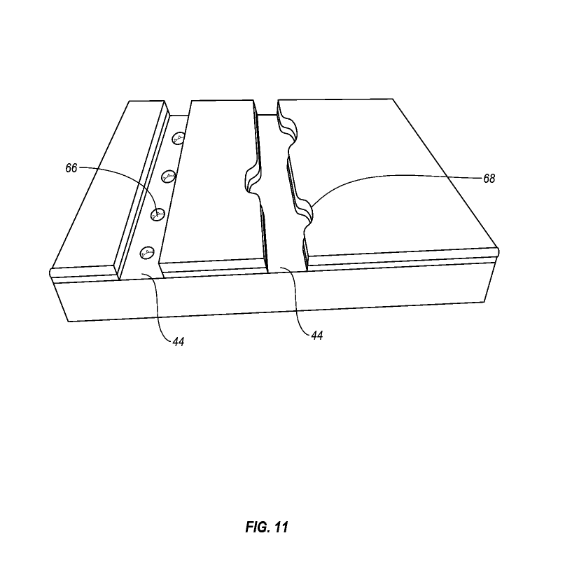

FIG. 11 is a perspective view of other features may be added to the grooves 44 in some embodiments. These features may be added in order to provide new characteristics of the friction-stir joined assembly 50. For example, in the left groove 44, one or more dimples 66 are made in the non-weldable work piece 40. These dimples 66 may provide various functions. For example, the dimples 66 may prevent sliding of the weldable work piece 42 along the grooves 44 by providing a physical barrier to sliding. It is noted that the dimples 66 may be filed by extrusion of the material in the weldable work piece 42 and the inserts 46 during friction stir welding.

FIG. 11 also illustrates that aspect of introducing one or more notches 68 in the grooves 44. The notches are shown along the length of the grooves 44 that extend into the material of the non-weldable work piece 40. The notches 68 may also prevent sliding of the weldable work piece 42 along the grooves 44.

It should be understood that other features may be added to the grooves 44 in order to prevent sliding of the weldable work piece 42, and these features should all be considered to be within the scope of the first or any other embodiments.

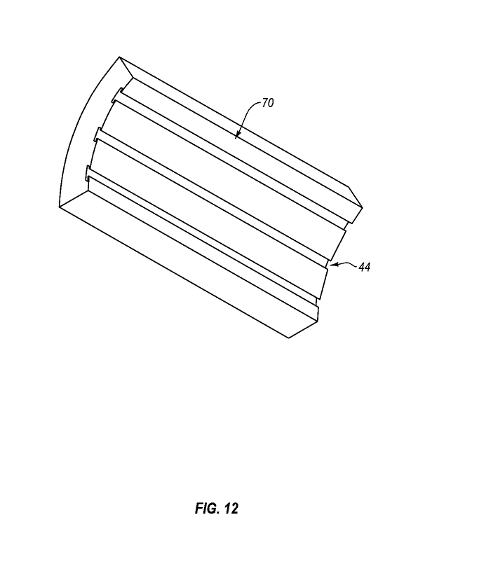

FIG. 12 is a perspective view of a second embodiment of the present disclosure. FIG. 12 shows a non-weldable work piece 70 that is curved or arcuate. The grooves 44 are shown disposed on a first side of the non-weldable work piece 70. In some embodiments, the grooves may be disposed on an opposite second side of the non-weldable work piece 70. Thus, the second embodiment enables the friction-stir joined assembly 50 to be disposed on arcuate surfaces such as on the inner diameter (“ID”) or outer diameter (“OD”) of pipes or other tubular objects, or on similar objects such as half pipes that function as a trough.

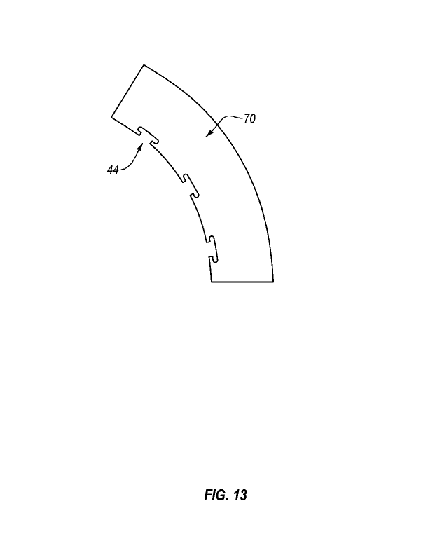

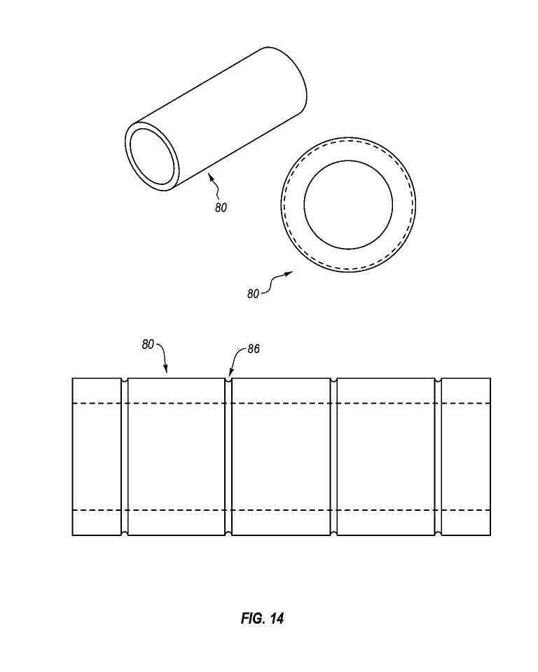

FIG. 13 is a cross-sectional view of the non-weldable work piece 70. The grooves 44 may be located along the ID of the arcuate non-weldable work piece 70 and may be open to the ID. The grooves 44 may extend toward the OD to allow the non-weldable work piece 70 to provide an attachable later to the OD of a weldable workpiece such as the curved and/or cylindrical weldable work pieces shown in FIGS. 14, 15, and 16.

FIGS. 14, 15, and 16 are of a third embodiment of the present disclosure where the objects forming a friction-stir joined assembly are tubulars such as pipes. FIG. 14 is three views of a high melting temperature material tubular object 80. The high melting temperature material tubular object 80 is shown in perspective, from an end relative to a long axis, and perpendicular to the axis. The high melting temperature material tubular object 80 includes grooves 86 disposed around a circumference.

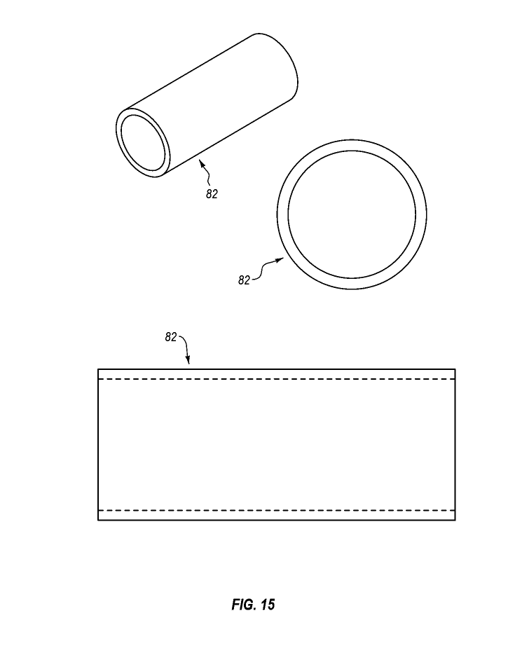

FIG. 15 is three views of a tubular object 82 that may form a weldable work piece for the tubular object 80. The weldable work piece tubular object 82 is shown in perspective, from an end relative to a long axis, and perpendicular to the axis. The weldable work piece tubular object 82 is large enough so that the OD of the high melting temperature material tubular object 80 fits inside the ID of the weldable work piece tubular object 82. The weldable work piece tubular object 82 may form a tight fit around the high melting temperature material tubular object 80.

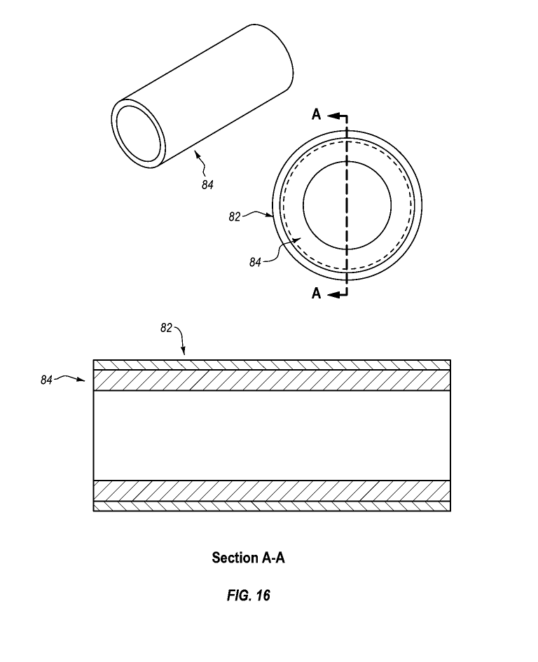

FIG. 16 is three views of a tubular assembly 84. The tubular assembly 84 is shown in perspective, from an end relative to a long axis, and perpendicular to the axis. The tubular assembly 84 may be formed by friction stir welding on the OD of the weldable work piece tubular object 82 over the grooves 86 in the high melting temperature material tubular object 80.

There may or may not be bars disposed within the grooves 86 in the tubular object 80. Accordingly, it may be possible to cause extrusion of material from the weldable work piece tubular object 82 to flow into the grooves 86 of the high melting temperature material tubular object 80 in order to fill the grooves. This means that the grooves 86 may or may not be sufficiently large enough to allow at least a partial penetration of a friction stir welding tool into the grooves 86.

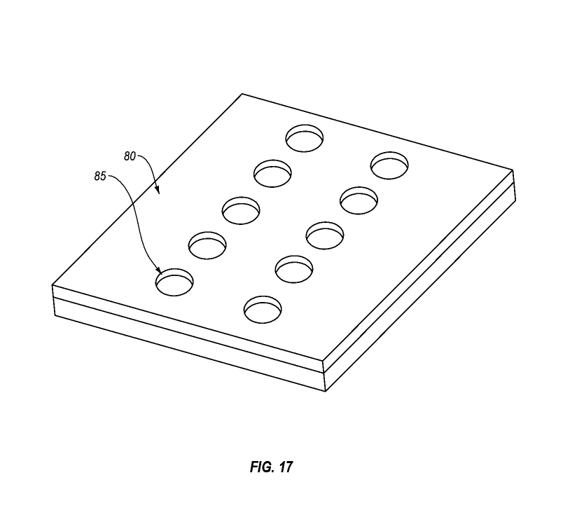

FIG. 17 is a perspective view of a non-weldable work piece 80 having at least one dovetailing depression or recess 85 with an opening that forms an ellipse or circle instead of a recess with length such as the grooves. Each of the dovetailed recesses 85 may be partially filled with a disk or an elliptical object (not shown) made of a material that may be friction stir welded. In some embodiments, the dovetailed recesses 85 are not filled with disks but may be filled by an extrusion of material from a weldable work piece during friction stir welding.

The size of the dovetailed recesses 85 may enable friction stir spot welding through a weldable work piece. In some embodiments, some movement of a friction stir welding tool may be used to cause extrusion of material from a weldable work piece into the recesses 85. The dovetailed recesses 85 may be formed as a cavity with an opening that is smaller than the cavity and thus forming an overhang. The dovetail or overhang may be formed while the non-weldable work piece 80 is in the green state or after it is hardened using a routing tool that can form the dovetail or overhanging shape.

A dovetail groove may be considered to include any type of groove where there is a cavity inside the groove that is larger than an opening into the groove when seen in a cross-sectional view. The dovetail groove may be formed while a non-weldable workpiece such as a high melting temperature material plate is in the green state or after hardening by using any appropriate routing tool.

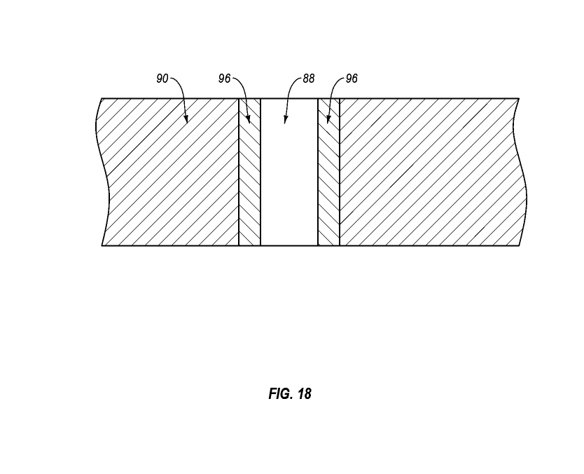

FIG. 18 is a cross-sectional illustration that shows an embodiment of a hole 88 may be formed in a non-weldable work piece 90 when it is in the green state. Instead of having a dovetailed recess 85 as in FIG. 17, material from a weldable work piece 96 may be extruded into the hole so that the material functions as a liner for an attaching device. For example, the hole 88 may have a steel lining of the weldable work piece 96 that may be threaded to enable the attachment of a bolt. The hole 88 may be filled with a filler material or with material from the weldable work piece 96.

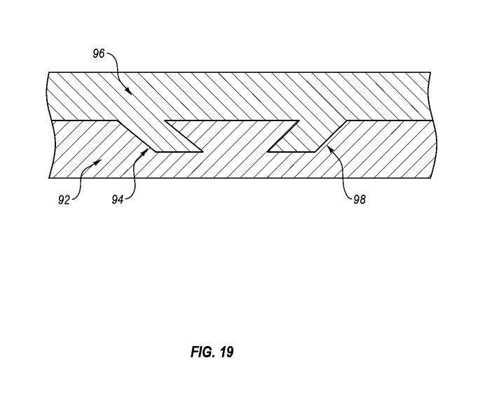

FIG. 19 is a cross-sectional illustration of an embodiment for construction of a non-weldable work piece 92 that may use one or more angled recesses at a non-parallel angle to one another to mechanically fix a non-weldable workpiece 92 to a weldable workpiece 96. Such embodiments may allow for mechanical locking using recesses other than the dovetailed recesses described herein. In some embodiments, a first angled recess 94 may be disposed into the non-weldable work piece 92. If the first angled recess 94 and a second angled recess 98 are not parallel to each other, then the first angled recess 94 and second angled recess 98 may lock a weldable work piece 96 to the non-weldable work piece 92 just by how the angled recesses are disposed relative to each other.

For example, FIG. 19 shows that a first angled recess 94 may be disposed at an angle shown or other angle and a second angled recess 98 may be disposed at a different and/or opposing angle so that once the weldable work piece 96 is attached to a filler material or once material from the weldable work piece is extruded into the first angled recess 94 and the second angled recess 98, an interference fit is created that enables attachment of the weldable work piece 96 to the non-weldable work piece 92.

It should be understood that the first angled recess 94 and the second angled recess 98 are not restricted to being straight holes. The first angled recess 94 and the second angled recess 98 may include any desired geometrical feature or shape that enables the recesses to lock the weldable work piece 96 to the non-weldable work piece 92.

In another embodiment of the disclosure, the weldable work piece may include a plurality of protrusions or projections. The plurality of projections may be pre-heated. The pre-heated projections may be heated sufficiently such that when the projections are forced into dovetailed grooves or dovetailed recesses of the non-weldable work piece, the plurality of projections on the weldable work piece may be deformed and expand into the dovetailed grooves or the dovetailed recesses, thereby creating the desired interference fit.

It should be understood that while the embodiments are directed to attaching a high melting temperature material to a weldable work piece, the principles of the embodiments are applicable to the mechanical joining of any two materials.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

Although the preceding description has been described herein with reference to particular means, materials, and embodiments, it is not intended to be limited to the particulars disclosed herein; rather, it extends to all functionally equivalent structures, methods, and uses, such as are within the scope of the disclosure. Accordingly, all such modifications are intended to be included within the scope of this disclosure. It is the express intention of the applicant not to invoke 35 U.S.C. § 112, paragraph 6 for any limitations of any of the claims herein, except for those in which the claim expressly uses the words ‘means for’ together with an associated function.

What is claimed is:

1. A friction stir joined assembly, the assembly comprising:
a non-weldable work piece having an outer surface and an opposite attaching surface;
at least one dovetailed recess disposed in the attaching surface;
an insert disposed in the dovetailed recess; and
a weldable work piece disposed against the attaching surface and friction stir welded to the insert, the insert forming an interference fit inside the at least one dovetailed recess after friction stir welding.

2. The friction-stir joined assembly as defined in claim 1 wherein the non-weldable work piece is selected from the group of materials consisting of tungsten carbide, alumina, silicon carbide, silicon nitride, polycrystalline diamond, polycrystalline cubic boron nitride, thermally stable polycrystalline diamond, synthetic sapphire, and aluminum oxynitride.

3. The friction-stir joined assembly as defined in claim 1 wherein the at least one dovetailed recess is comprised of a plurality of dovetailed grooves that are linear.

4. The friction-stir joined assembly as defined in claim 1 wherein the at least one dovetailed recess is comprised of a plurality of dovetailed recesses formed with an opening in the form of an ellipse.

5. The friction-stir joined assembly as defined in claim 1 wherein the weldable work piece is selected from a group of materials consisting of steel, stainless steel, aluminum, and high nickel alloys such as Inconel.

6. The friction-stir joined assembly as defined in claim 1 wherein the at least one dovetailed recess is further comprised of at least one dimple formed therein.

7. The friction-stir joined assembly as defined in claim 1 wherein the at least one dovetailed recess is further comprised of at least one notch that extends into the non-weldable work piece.

8. The friction-stir joined assembly as defined in claim 1 wherein the non-weldable work piece is cylindrical, wherein the weldable work piece is configured to be connected to an outer surface of the cylindrical non-weldable work piece.

9. A friction-stir joined assembly comprising:
a non-weldable work piece having a outer surface and an opposite attaching surface;
at least one dovetailed recess disposed in the attaching surface; and
a weldable work piece disposed against the attaching surface and extruded into the at least one dovetailed recess by friction stir welding, an extrusion from the weldable work piece forming an interference fit inside the at least one dovetailed recess.

10. The friction-stir joined assembly as defined in claim 9 wherein the attachment device is selected from the group of attachment devices consisting of threaded screws and rods with cotter pins.

11. The friction-stir joined assembly as defined in claim 9 wherein the at least one dovetailed recess is comprised of a plurality of dovetailed grooves that are linear, and wherein at least one of the plurality of dovetailed grooves crosses at least another one of the plurality of dovetailed grooves.

12. A method of manufacturing a friction-stir joined assembly, said method comprising:
forming a non-weldable work piece into a desired shape, selecting a outer surface and an opposite attaching surface;
forming a plurality of dovetailed recesses in the attaching surface;
disposing an insert into each of the plurality of dovetailed recesses; and
disposing a weldable work piece against the attaching surface and friction stir welding the weldable work piece to each of the inserts, the inserts forming an interference fit inside the plurality of dovetailed recesses after friction stir welding.

13. The method as defined in claim 12 wherein the method further comprises selecting the non-weldable work piece from the group of high melting temperature materials consisting of tungsten carbide, aluminum oxide, silicon carbide, silicon nitride, polycrystalline diamond, polycrystalline cubic boron nitride, thermally stable polycrystalline diamond, synthetic sapphire, and aluminum oxynitride.

14. The method as defined in claim 12 wherein the method further comprises forming the plurality of dovetailed recesses as a plurality of dovetailed grooves that are linear and parallel.

15. The method as defined in claim 12 wherein the method further comprises forming the plurality of dovetailed recesses as a plurality of dovetailed grooves that are linear and wherein at least one of the plurality of dovetailed grooves crosses at least another one of the plurality of dovetailed grooves.

16. The method as defined in claim 12 wherein the method further comprises forming the plurality of dovetailed recesses with an opening in the form of an ellipse.

17. The method as defined in claim 12 wherein the method further comprises selecting the weldable work piece from a group of materials consisting of steel, stainless steel, aluminum, and high nickel alloys such as Inconel.

18. The method as defined in claim 12 wherein the method further comprises selecting the attachment device from the group of attachment devices consisting of threaded screws and rods with cotter pins.

19. The method as defined in claim 12 wherein the method further comprises forming the non-weldable work piece and the weldable work piece as arcuate objects.

20. The method as defined in claim 12 wherein the method further comprises mechanically coupling the weldable work piece to another device in order to provide an outer surface.
